(19) United States
(12) Patent Application Publication
(10) Pub. No.: US 2009/0138891 A1
(43) Pub. Date: May 28, 2009

(54) INTEGRATING SERVICE-ORIENTED ARCHITECTURE APPLICATIONS WITH A COMMON MESSAGING INTERFACE

(76) Inventors: Robert J. Winig, Rancho Palo Verdes, CA (US); Karen K. Luk, Torrance, CA (US); Kevin A. Stone, Hermosa Beach, CA (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 11/945,515

(22) Filed: Nov. 27, 2007

(51) Int. Cl. G06F 3/00

(52) U.S. Cl. 719/313

(57) ABSTRACT

A method for communicating between a first client application and a second client application is described where, the client applications incorporate different messaging interfaces. The method includes outputting a message from the first client application, the message having a first messaging interface, translating the message, having a first messaging interface, to a common messaging interface (CMI) with an interface adapter to interface the application to the CMI, utilizing a middleware adapter to translate the message, in the common messaging interface, into a second messaging interface, and forwarding the message, having the second messaging interface, to the second client application.

### FIELD

This disclosure relates generally to messaging interfaces for applications, and more specifically, to integrating applications into a service-oriented architecture using a common messaging interface.

### BACKGROUND

Service-oriented architecture (SOA) is an architecture that enables loosely coupled services or applications to exchange data or to communicate with each other via messaging techniques or protocols. The architecture is not tied to a specific technology. Applications that conform to SOA may be implemented using a wide range of standard messaging interfaces/protocols including JMS (Java messaging service), JBI (joint battlespace infosphere), DDS (distributed data service), CORBA (common object request broker architecture), and Web Services (HTTP, WSDL, SOAP) just to name a few. There is a variety of commercial, government, and open source message oriented middleware (MOM) applications that implement these interfaces/protocols. Examples of these applications include: JBOSS and ActiveMQ (JMS implementation providers) and RTI-DDS (DDS implementation provider).

The MOM enables the applications to connect and communicate via an application programming interface (API) or messaging interface, and to provide/consume data or information via the payload of the message without having foreknowledge of the services/applications or how a service performs its task. However, interoperability issues arise when integrating disparate applications from different middleware platforms where different API's are used. With the goal of providing interoperability of applications or services the demand for sharing applications or services from multiple different organizations becomes more apparent while attempting to interface and integrate these applications or services from organizations using different middleware platforms.

One fairly quick solution to the issue is to develop code to interface different MOM implementations. However, this solution is not scalable and is specific to one or two MOM implementations, and not feasible in applications where more than two MOMs are to be bridged. A scalable solution of this type is rare and may require additional infrastructure.

### SUMMARY

In one aspect, a method for communicating between a first client application and a second client application is provided where the client applications incorporate different messaging interfaces. The method includes outputting a message from the first client application, the message having a first messaging interface, translating the message, having a first messaging interface, to a common messaging interface (CMI) using an interface adapter to interface the application to the CMI, utilizing a middleware adapter to translate the message, in the common messaging interface, into a second messaging interface, and forwarding the message, having the second messaging interface, to the second client application.

In another aspect, a method for communicating with one or more applications in a system utilizing a service oriented architecture (SOA) is provided. The SOA implements a first middleware platform implementation, and at least one of the applications is designed for interfacing to a second middleware platform implementation that is different than the first middleware platform implementation. The method includes executing a common messaging interface (CMI) layer in the SOA environment such that each of the one or more applications in the SOA environment directly interface with the CMI layer, automatically intercepting a messaging call at the CMI layer from a first of the one or more applications, the intercepted function call based on the second middleware platform implementation, the second middleware platform implementation different from the first middleware platform implementation, determining an equivalent intermediate message protocol for the intercepted call from a predefined common message interface based on the application's middleware platform interface, determining an equivalent target message protocol for the intermediate message protocol based on the message destination, and sending the message by executing said determined equivalent target message protocol, wherein the target message protocol is operable in the SOA environment using the first middleware platform implementation.

In still another aspect, a system implementing a service oriented architecture (SOA) is provided that comprises a first application, a first middleware platform implementation, the first application designed to interface with the first middleware platform implementation, a second application incompatible with an interface associated with the first middleware platform implementation, and a common messaging interface (CMI) layer. The CMI layer is configured to intercept a message from the second application, determine an equivalent intermediate message protocol for the intercepted message using a predefined common message interface based on a middleware platform interface associated with the second application, determine an equivalent target message protocol for the intermediate message protocol based on the message destination being the first application, and send the message by executing the equivalent target message protocol, which is compatible with the first middleware platform implementation.

In yet another aspect, a common messaging interface system for integrating applications in a service oriented architecture is provided. The common messaging interface system includes an interface adapter coded to translate an intercepted message call based on a first middleware platform implementation associated with a first application to a predefined common message interface, and a middleware adapter coded to translate message calls associated with the predefined common message interface to a messaging interface compatible with a middleware platform implementation different than the first middleware platform implementation.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 illustrates functions associated with a common messaging interface.

FIG. 2 illustrates the normal control flow of message publish/subscribe clients and a middleware in a given data domain or service oriented architecture (SOA) environment.

FIG. 3 illustrates the structure and control flow of the common messaging interface in a message publish/subscribe application within a SOA environment.

FIG. 4 is an example application for incorporating the common messaging interface into different SOA environment.

FIG. 5 illustrates the structure of the common messaging interface in the layers of the SOA.

FIG. 6 is an example of a general bridging or translation solution that is currently utilized for a multiple middleware environment.

FIG. 7 illustrates a first client application communicating with a second client using a service oriented architecture frame that allows a single middleware implementation to be utilized for both client applications.

### DETAILED DESCRIPTION

The described embodiments solve the interoperability issue of information systems employing a service oriented architecture (SOA) described above by providing a software solution that allows the services that have a standard application programming interface (API) to plug into any SOA environment without any additional code being required. Therefore, such embodiments are structured so that integration is seamless, scalable to adapt additional messaging interface and middleware, requires no additional code for a client application to use a different middleware, and requires no additional infrastructure, for example, such as a server. In other words, the described embodiments enable systems employing a SOA that are based on different middleware platform implementations to be interoperable, using a single middleware platform implementation, while still minimizing integration effort.

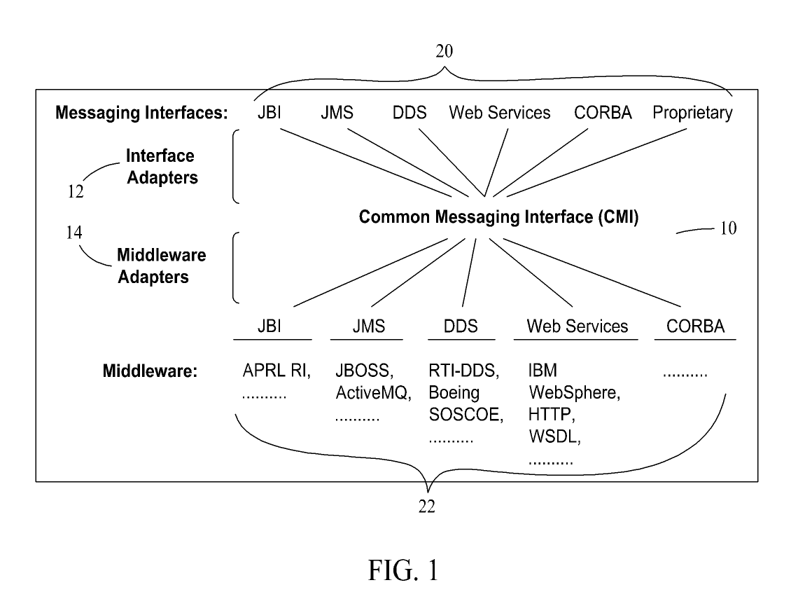

As will be evident from the following descriptions, capabilities are provided that enable client applications to be able to communicate with different middleware platform implementations and share services from different data domains or SOA implementations. FIG. 1 is a simplified illustration of a common messaging interface (CMI) 10 which includes messaging interface adapters 12 and middleware adapters 14. As further described herein, the CMI 10 provide an interface between various messaging interfaces 20 and middleware platform implementations 22.

The messaging interface adapter 12 maps a messaging interface or application programming interface (API) call to the common messaging interface (CMI) 10 or API call. The CMI 10 handles basic messaging functionalities such as publish/subscribe or peer-to-peer connection, establishing session, registering topic, message delivery, among others. The CMI 10 includes a message format that allows each interface to be able to represent its message content in a common format.

The messaging middleware adapter 14 performs the messaging functions of the CMI 10 using a target middleware platform. In another words, the middleware adapter 14 utilizes the target middleware platform for message transport. In specific applications, there might not be a one-to-one function mapping between a messaging interface and a middleware platform, for example, a JMS interface and RTI-DDS middleware as shown in FIG. 1. In such an application, the middleware adapter 14 simulates the function specified by the messaging interface 20 that is not being supported by the underlying middleware platform implementation 22.

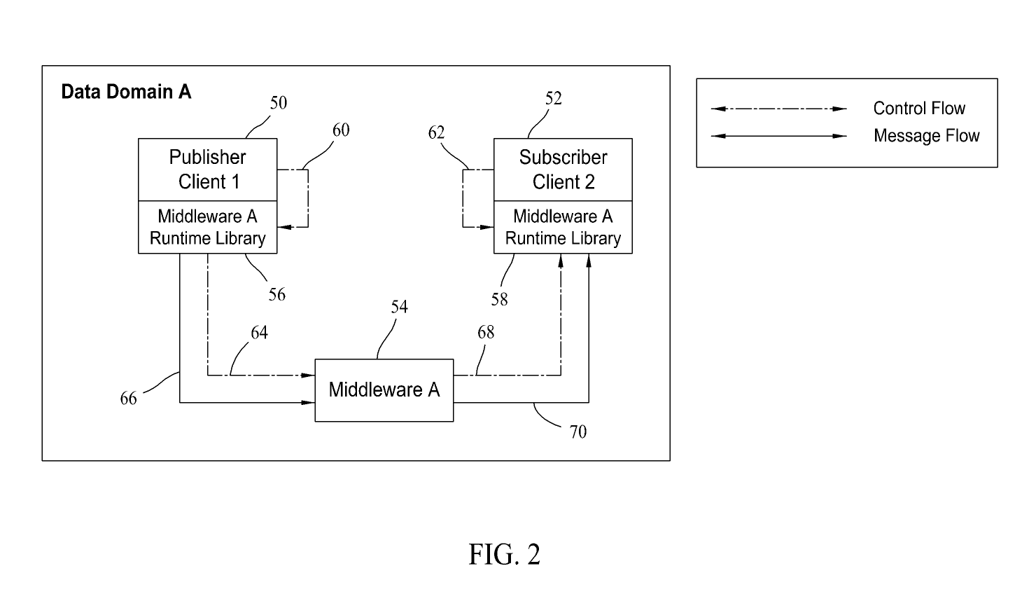

FIG. 2 illustrates a normal control flow of messages between a publisher client 50 and a subscriber client 52 and a middleware A implementation 54 in a given data domain. Both the publisher client 50 and the subscriber client 52 are clients of the middleware A implementation 54. Therefore, the clients 50 and 52 are configured to run with runtime libraries 56 and 58 respectively, of the middleware A implementation 54. A normal sequence of events relating to messages passed between the publisher client 50 and the subscriber client 52 are described in the following paragraphs.

The publisher client 50 makes one or more middleware A API connections 60 to the middleware A runtime library 56. Separately, the subscriber client 52 makes one or more middleware A API connections 62 to its respective middleware A runtime library 56. When, for example, a ‘publish/send/write-message’ connection 64 is made utilizing the middleware A runtime library 56, the middleware A implementation 54 takes the message received from the publisher client 50 and stores it. Subsequently, the publisher client 50 publishes/sends/writes one or more messages 66 to the middleware A implementation 54.

When a ‘subscribe/receive/read-message’ connection 68 is made, the middleware A implementation 54 delivers to the subscriber client 52 the message(s) that satisfied subscription criteria (such as topic). Subsequently, the middleware A implementation 54 distributes the message(s) 70 to the subscriber client 52.

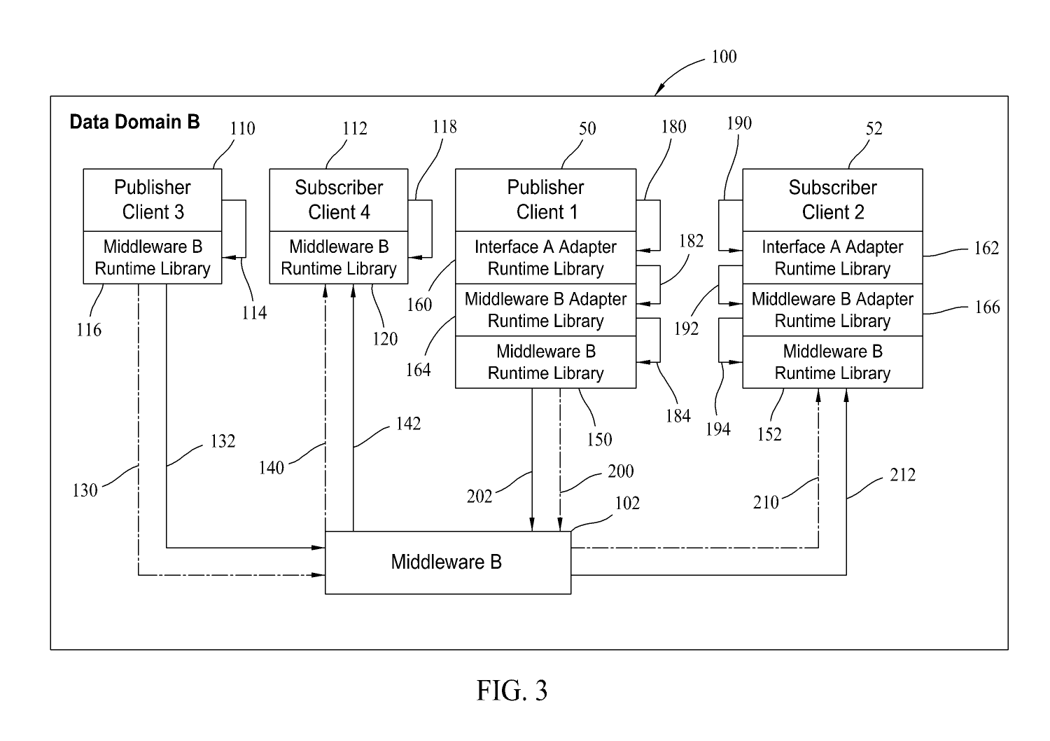

The embodiments illustrated by FIG. 2 are representative of the situation where both a publisher and subscriber client are implemented to utilize a single middleware platform implementation. FIG. 3 illustrates a structure and control flow as it relates to publisher and subscriber clients that are not implemented to utilize a single middleware platform implementation. More specifically, FIG. 3 illustrates a data domain 100 where the same publisher and subscriber clients 50 and 52 from FIG. 2 have been integrated. As will be further explained, integration into data domain 100 raises issues for such clients as data domain 100 utilizes a different middleware platform implementation, which is referred to herein as a middleware B implementation 102. Further, embodiments are illustrated and described with respect to data domain 100 as providing a solution to interoperation with different middleware implementations used by different data domains.

Now referring specifically to FIG. 3, in addition to publisher client 50 and a subscriber client 52, a publisher client 110 and a subscriber client 112 are included in the data domain 100.

Similar to the implementation described in FIG. 2, the publisher client 110 makes one or more middleware B API connections 114 to a middleware B runtime library 116. Separately, the subscriber client 112 makes one or more middleware B API connections 118 to its respective middleware B runtime library 120. When, for example, a ‘publish/send/write-message’ connection 130 is made utilizing the middleware B runtime library 116, the middleware B implementation 102 takes the message received from the publisher client 110 and stores it. Subsequently, the publisher client 110 publishes/sends/writes one or more messages 132 to the middleware B implementation 102.

When a ‘subscribe/receive/read-message’ connection 140 is made, the middleware B implementation 102 delivers to the subscriber client 112 the message(s) that satisfied subscription criteria (such as topic). Subsequently, the middleware B implementation 102 distributes the message(s) 142 to the subscriber client 112.

The publisher client 50 and the subscriber client 52, are configured to interface to a middleware A implementation based on utilization of the middleware A runtime libraries shown in FIG. 2. In data domain 100, which utilizes the middleware B implementation 102, embodiments are incorporated, further described below, that allow utilization of the publisher client 50 and the subscriber client 52.

To be integrated into data domain 100, clients 50 and 52 are to be made compatible with middleware B runtime libraries 150 and 152 respectively. However, the clients 50 and 52 utilize the message interface of the Middleware A implementation (shown in FIG. 2) which is different than the message interface used by the Middleware B implementation 102.

To address these discrepancies, data domain 100 incorporates interface A adapter runtime libraries 160 and 162 and middleware B adapter runtime libraries 164 and 166. These runtime libraries 160, 162, 164, and 166 are respectively plugged in between the client applications (the publisher client 50 and the subscriber client 52) and the respective middleware B runtime libraries 150 and 152. The runtime libraries 160, 162, 164, and 166 are sometimes collectively referred to as a bridging solution. A sequence of events, for example, message publish and subscribe, utilizing the bridging solution with the publisher client 50 and the subscriber client 52 is below.

More specifically, the publisher client 50 makes a middleware A API connection 180. This API connection 180 is received by the interface A adapter runtime library 160, the interface A adapter runtime library 160 being coded to make a connection 182 to the corresponding common messaging interface (CMI) API in middleware B adapter runtime library 164. More generically, this process is described as the middleware A application programming interface (API) making a connection 182 to the corresponding common messaging interface (CMI) API.

From the middleware B adapter runtime library 164, the CMI API (e.g., middleware B adapter runtime library 164) makes connection(s) 184 to the corresponding middleware-B API(s) (e.g., middleware B runtime library 150) to perform the messaging functions.

Now in regard to subscriber client 52, it also makes a middleware A API connection 190. This API connection 190 is received by the interface A adapter runtime library 162, the interface A adapter runtime library 162 being coded to make a connection 192 to the corresponding common messaging interface (CMI) API in middleware B adapter runtime library 166. As above, this process is sometimes described as the middleware A application programming interface (API) making a connection 192 to the corresponding common messaging interface (CMI) API.

From the middleware B adapter runtime library 166, the CMI API (e.g., middleware B adapter runtime library 166) makes connection(s) 194 to the corresponding middleware-B API(s) (e.g., middleware B runtime library 152) to perform the messaging functions.

The interface A adapter runtime libraries 160 and 162 are coded (or programmed) for each interface A API (or function) to call the corresponding common message interface (CMI) API (or function) based on the interface A specification and CMI specification (i.e. a process to translate or map the specified message functionality from interface A to the common message interface).

The middleware B adapter runtime libraries 162 and 164 are coded (or programmed) for each common message interface (CMI) API (or function) to call one or more corresponding middleware B APIs (or functions) based on the CMI specification and the specification of interface B associated with middleware B (i.e. a process to translate or map the specified message functionality from the common message interface to middleware B).

Still referring to FIG. 3, when for example, a ‘publish/send/write-message’ API connection 200 is made, the middleware B 102 takes the message originating from the publisher client 50 and stores it. The publisher client 50 then publishes/sends/writes 202 messages to middleware B 102.

When a ‘subscribe/receive/read-message’ API connection 210 is made, the middleware B 102 delivers to the subscriber client 102 the message(s) that satisfied the subscription criteria (such as topic) through the libraries and adapters described above. Specific to FIG. 3, middleware B 102 distributes the messages to Subscriber Client 52.

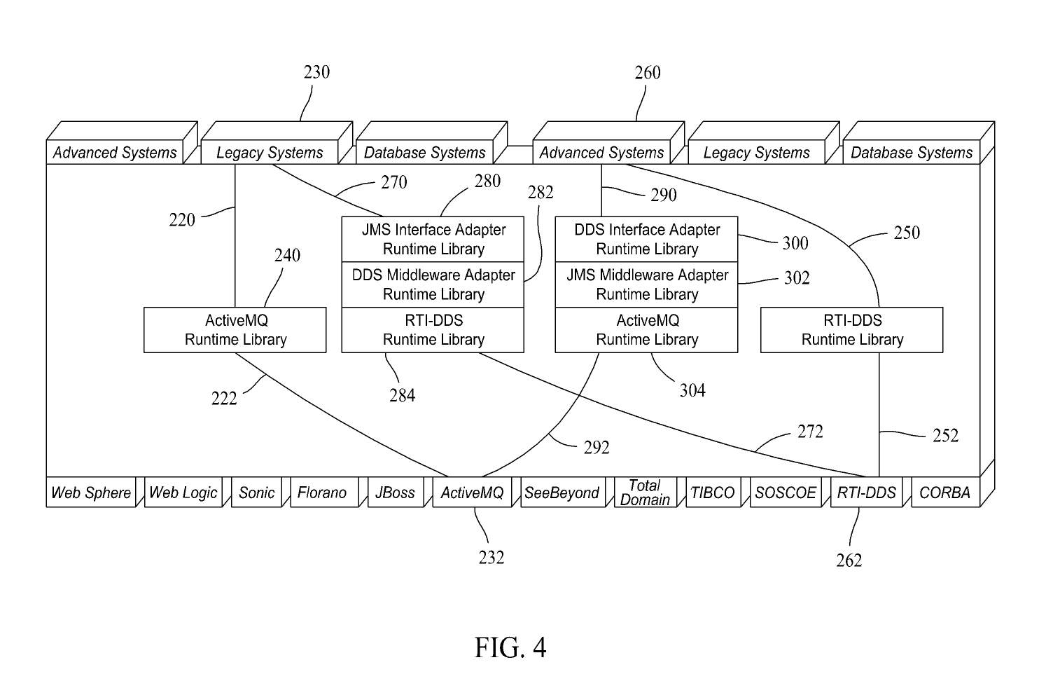

While the embodiments illustrated by FIG. 3 are somewhat generic, FIG. 4 illustrates a specific embodiment which incorporates a common messaging interface. In FIG. 4, connections 220 and 222 illustrate that the legacy system clients 230 are based on ActiveMQ middleware 232, for example, which is JMS interface based. For an implementation of the legacy system clients 230 are JMS interface based and utilize an ActiveMQ runtime library 240. Similarly, connections 250 and 252 illustrate that advanced system clients 260 are based on a RTI-DDS middleware implementation 262 which is DDS interface based, and operable with a RTI-DDS runtime library 264. Therefore, any of the advanced system clients 260 are DDS interface based.

More relevant to the current disclosure, connections 270 and 272 illustrate that the legacy system clients 230, which in the example are JMS interface based, interoperates with the RTI-DDS middleware 262 via a JMS interface adapter runtime library 280 and a DDS middleware adapter runtime library 282. The adapter runtime libraries 280 and 282 enable the JMS interface based legacy system clients 230 to utilize the RTI-DDS runtime library 284 to interoperate with RTI-DDS middleware 262. Reiterating, the connections 270 and 272 illustrate that the JMS interface based clients of the legacy system 230 are bridged from a JMS interface to the RTI-DDS middleware 262.

Similarly, connections 290 and 292 illustrate that the advanced system clients 260 interoperates with ActiveMQ middleware 232 via a DDS interface adapter runtime library 300 and a JMS middleware adapter runtime library 302. The adapter runtime libraries 300 and 302 enable the DDS interface based advanced system clients 260 to utilize the ActiveMQ runtime library 304 to interoperate with ActiveMQ middleware 232. Reiterating, the connections 290 and 292 illustrate that the DDS interface based clients of the Advanced Systems are bridged from the DDS interface to the ActiveMQ middleware 232.

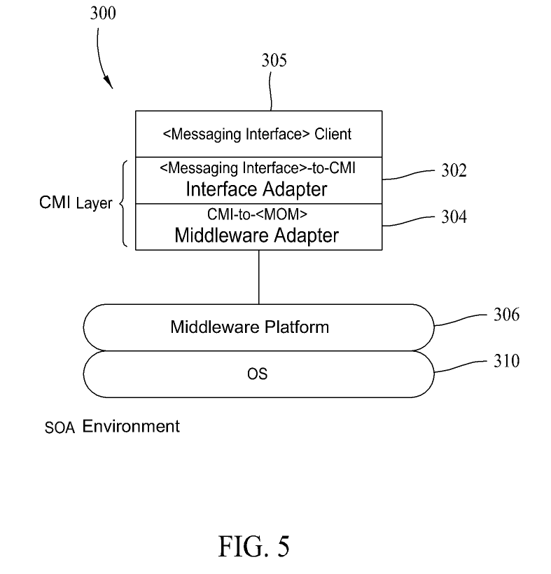

FIG. 5 illustrates the above described embodiments utilizing a CMI approach. Specifically, and referring to SOA environment 300, the CMI approach is to provide a messaging interface adapter 302, and a messaging middleware adapter 304 which collectively are sometimes referred to as a common messaging interface. Specifically, the messaging interface adapter 302 translates the messaging interface of a client application 305 to a common messaging interface (CMI) and the messaging middleware adapter 304 translates the CMI interface to the middleware platform 306 of the underlying messaging protocol, providing a messaging interface, for example, to an operating system 310.

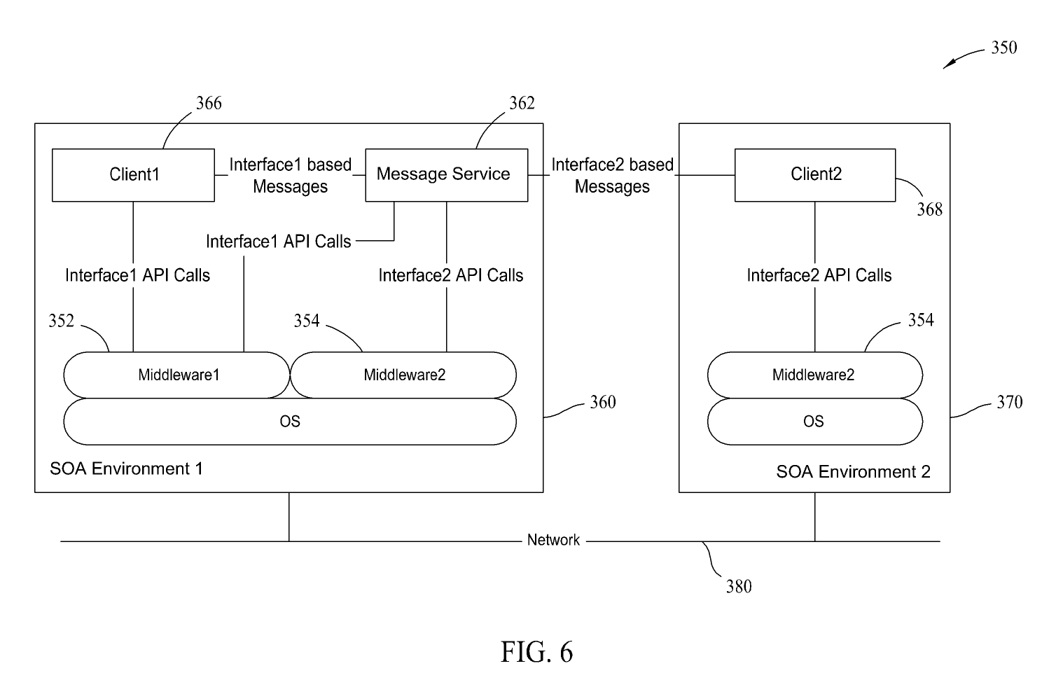

FIG. 6 is another example of a general bridging or translation solution for a multiple middleware environment 350, which is currently in use. In environment 350, two different middleware platform implementations 352 and 354 are incorporated into environment 360 as is a message service 362. The first middleware platform implementation 352 handles API connections and other messaging needs of a client application 366, as they employ a common messaging interface. The message service 362 is implemented to provide translation of messages and calls from the first middleware platform implementation 352 such that they are made compatible with the second middleware platform application 354 so that environments 360 and 370 can communicate or exchange messages (or data) via network 380. In such a solution, environment 360 requires both middleware platform implementations 352 and 354 that are to be bridged or translated.

Reiterating, the message service 362 is custom programmed to translate only between the first middleware platform implementation 352 and the second middleware platform implementation 354 and does not incorporate a common messaging interface as is found in the herein described embodiments.

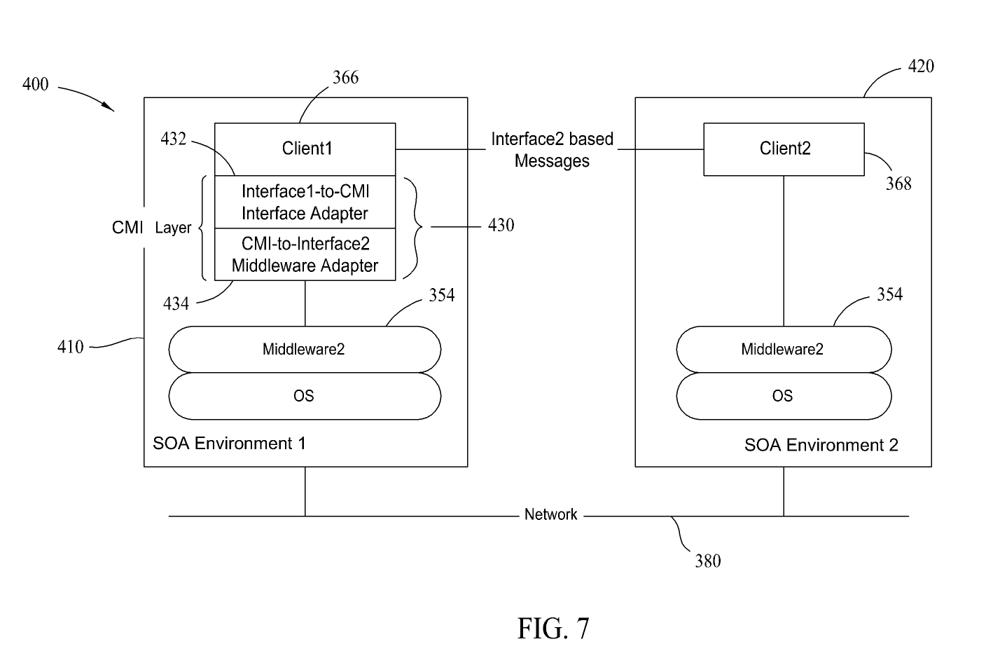

The environment 400 of FIG. 7 provides the same functionality as that of environment 350 (shown in FIG. 6) as shown by environments 410 and 420, except that the client application 366 is able to communicate with client application 368, via network 380, using only the second middleware platform implementation 354 in each environment 410 and 420, through the utilization of CMI layer 430. This solution is possible due to the translation of the messaging received from client application 366 to be compatible with that of middleware platform implementation 354 by translation of the client application 366 message to a common messaging interface (CMI). The translation to CMI occurs within interface adapter 432 and the subsequent translation of the CMI interface to be compatible with that of middleware platform implementation 354 occurs within middleware adapter 434. Therefore separate instances of a single middleware platform implementation 354 are utilized to route messages between SOA environments 410 and 420.

In summary, middleware adapter 434 implements the common messaging interface described above using a middleware platform. In another words, the middleware adapter 434 uses the available middleware platform 354 for transport. There might not be a one-to-one function mapping between a messaging interface (for client 366) and a middleware platform implementation 354. An example of middleware platforms are ActiveMQ and RTI-DDS. In such a case, as illustrated in FIG. 7, the middleware adapter 434 simulates the functionality specified by the messaging interface that is not being supported by the middleware platform.

The above described embodiments are different from currently utilized solutions in at least two ways. One, the embodiments bridge a messaging interface and middleware platform rather than a specific client application. As a result, such embodiments are scalable, modular, and provide seamless integrations between client applications (messaging interfaces) and middleware platform implementations. Therefore, the above described embodiments are an overall scalable solution that addresses a wide range of seemingly conflicting messaging interfaces and middleware solutions. The embodiments provide basic messaging functionalities, for example, publish subscribe, peer to peer connection, establish session, register topic, message delivery.

The above described embodiments are not simply a translation tool. Rather, the embodiments result in a method of being able to host applications into an SOA environment with a middleware platform in which the application was not designed for, without having to modify the software of the application. The solution is the framework which insulates the application from the underlying middleware implementation of the SOA environment and automatically intercepts messaging APIs in the original middleware of the application, and determines the appropriate message format as well as a protocol/sequence of messaging needed by the destination of the message. Applications are hosted into the framework by configuring the runtime library of the application instead of developing new translators.

While the invention has been described in terms of various specific embodiments, those skilled in the art will recognize that the invention can be practiced with modification within the spirit and scope of the claims.

What is claimed is:

1. A method for communicating between a first client application and a second client application, the client applications incorporating different messaging interfaces, said method comprising:
outputting a message from the first client application, the message having a first messaging interface;
translating the message, having a first messaging interface, to a common messaging interface (CMI) using an interface adapter to interface the application to the CMI;
utilizing a middleware adapter to translate the message, in the common messaging interface, into a second messaging interface; and
forwarding the message, having the second messaging interface, to the second client application.

2. A method according to claim 1 wherein outputting a message comprises initiating at least one of an application programming interface call and a connection.

3. A method according to claim 1 wherein forwarding the message to the second client application comprises making an application programming interface call to a runtime library coded to utilize the second messaging interface.

4. A method according to claim 1 wherein translating the message to a common messaging interface with an interface adapter comprises forwarding the message in an application programming interface call to a runtime library coded to translate the first messaging interface to the common messaging interface.

5. A method according to claim 1 wherein utilizing a middleware adapter to translate the message comprises in the common messaging interface, forwarding the message in an application programming interface call to a runtime library coded to translate the common messaging interface to the second messaging interface.

6. A method according to claim 1 wherein the messaging interfaces may be different types of a Java Messaging Service, a Distributed Data Service, a Common Object Request Broker Architecture, a Web Service Description Language, and a Simple Object Access Protocol.

7. A method according to claim 1 wherein the first and second messaging interfaces are intended for runtime libraries associated with different middleware platform implementations.

8. A method for communicating with one or more applications in a service oriented architecture (SOA) environment, the SOA environment implementing a first middleware platform implementation, and at least one of the applications designed for interfacing to a second middleware platform implementation different than the first middleware platform implementation, said method comprising:
executing a common messaging interface (CMI) layer in the SOA environment such that each of the one or more applications in the SOA environment directly interface with the CMI layer;
automatically intercepting a messaging call at the CMI layer from a first of the one or more applications, the intercepted function call based on the second middleware platform implementation, the second middleware platform implementation different from the first middleware platform implementation;
determining an equivalent intermediate message protocol for the intercepted call from a predefined common message interface based on the application's middleware platform interface;
determining an equivalent target message protocol for the intermediate message protocol based on the message destination; and
sending the message by executing said determined equivalent target message protocol, wherein the target message protocol is operable in the SOA environment using the first middleware platform implementation.

9. The method of claim 8 further comprising automatically intercepting a messaging call at the CMI layer from a second of the one or more applications, the intercepted call based on a third middleware platform, the third middleware platform different from the first middleware platform and the second middleware platform.

10. The method of claim 8 further comprising configuring each of the one or more applications runtime library to enable the application in the SOA environment.

11. A system implementing a service oriented architecture (SOA) comprising:
a first application;
a first middleware platform implementation, said first application designed to interface with said first middleware platform implementation;
a second application, said second application incompatible with an interface associated with said first middleware platform implementation; and
a common messaging interface (CMI) layer, said CMI layer configured to intercept a message from said second application, determine an equivalent intermediate message protocol for the intercepted message using a predefined common message interface based on a middleware platform interface associated with said second application, determine an equivalent target message protocol for the intermediate message protocol based on the message destination being said first application, and send the message by executing the equivalent target message protocol, which is compatible with said first middleware platform implementation.

12. A system according to claim 11 wherein said CMI layer comprises an interface adapter runtime library, said library coded to translate the intercepted message to the common message interface.

13. A system according to claim 11 wherein said CMI layer comprises a middleware adapter runtime library, said library coded to translate the intercepted message from the common message interface to a messaging interface compatible with said first middleware platform implementation.

14. A system according to claim 11 wherein the message associated with said first application and said second application comprise at least one of a connection or an application programming interface call.

15. A system according to claim 11 wherein to execute the equivalent target message protocol, said CMI layer is configured to make a call to a runtime library compatible with said first middleware platform implementation.

16. A system according to claim 11 wherein the interfaces associated with said first application and said second application comprise different types of Java Messaging Service, Distributed Data Service, Common ObjectRrequest Broker Architecture, and Web Service Description Language, and Simple Object Access Protocol.

17. A common messaging interface system for integrating applications in a service oriented architecture, said common messaging interface system comprising:
an interface adapter coded to translate an intercepted message call based on a first middleware platform implementation associated with a first application to a predefined common message interface; and
a middleware adapter coded to translate message call associated with the predefined common message interface to a messaging interface compatible with a middleware platform implementation different than the first middleware platform implementation.

18. A common messaging interface system according to claim 17 wherein said interface adapter and said middleware adapter each comprise runtime libraries.

19. A common messaging interface system according to claim 17 wherein said interface adapter is coded to intercept at least one messages or application programming interface call messages.

20. A common messaging interface system according to claim 17 wherein said middleware adapter is coded to make a call to a runtime library compatible with a middleware platform implementation different than the first middleware platform implementation.
